(19) United States
(12) Patent Application Publication
(10) Pub. No.: US 2007/0069021 A1
(43) Pub. Date: Mar. 29, 2007

(54) Smart floor tiles/carpet for tracking movement in retail, industrial and other environments

(75) Inventors: Scott A. Elrod, La Honda, CA (US); Eric Shrader, Belmont, CA (US)

Correspondence Address: Mark S. Svat;FAY, SHARPE, FAGAN, MINNICH & McKEE, LLP, SEVENTH FLOOR, 1100 SUPERIOR AVENUE, CLEVELAND, OH, 44114-2579, US

(73) Assignee: PALO ALTO RESEARCH CENTER INCORPORATED

(21) Appl. No.: 11/236,681

(22) Filed: Sep. 27, 2005

(51) Int. Cl. G06K 7/08; G06Q 30/00

(52) U.S. Cl. 235/451; 235/385

(57) ABSTRACT

In one embodiment, provided is a sensing element including a transducer configured to convert mechanical pressure into an electrical signal. Also provided is an RFID tag having a first section configured to employ at least a portion of the electrical signal as a trigger signal, wherein the trigger signal causes the RFID tag to generate and transmit an RFID identification signal.

### BACKGROUND

The present application is directed to a method and apparatus of sensing and monitoring, and more particularly, to sensing and monitoring movement of people and objects across a surface.

Retailers spend substantial amounts of money to understand the detailed movement of shoppers in stores. Often this is accomplished by stationing personnel at various locations in the store to understand specific traffic patters. Also, government agencies are interested in traffic usage on streets, as well as through crosswalks, in order to determine traffic patterns. The common process for determining traffic patterns is, again, manual, where individuals are located on streets to count pedestrian and/or automobile traffic. Alternatively, for automobile traffic, more mechanized and/or automated count systems, such as magnetic loops, pneumatic detectors, among others, may also be used.

Thus, current methods tend to be expensive, and it is difficult to track movements in buildings, roads and other locations on a continuous basis. The present application is directed to components, systems and designs for the automation of sensing and monitoring people, vehicles or other objects.

### BRIEF DESCRIPTION

In one embodiment, provided is a sensing element including a transducer configured to convert mechanical energy into an electrical signal, and an RFID tag having a first section configured to employ at least a portion of the electrical signal as a trigger signal, wherein the trigger signal causes the RFID tag to generate and transmit an RFID signal. In one embodiment, the RFID tag is an active tag, while in an alternative embodiment, the RFID tag is passive.

### BRIEF DESCRIPTION OF THE DRAWINGS

FIG. 1 is a bottom view of a sensing element and a base station with which it interacts;

FIG. 2 shows a more detailed drawing of a portion of the sensing element related to the storage of a charge on the sensing element;

FIG. 3 is directed to a second embodiment of a sensing element, which provides a self-powering aspect;

FIG. 4 illustrates a side view of the operation regarding the sensing elements of FIGS. 1-3;

FIG. 5 illustrates a second embodiment related to the construction regarding the sensing elements of FIGS. 1-3;

FIG. 6 depicts a plurality of sensing elements of a monitoring system and initialization of the system;

FIG. 7 illustrates a plurality of sensing elements located on a continuous flooring material such as linoleum, carpet or other continuous role;

FIG. 8 illustrates the use of the sensing elements in conjunction with a strip of road-tape, which may be used in outdoor environments;

FIG. 9 illustrates the concepts of the present application in a multi-hop communication network; and

FIG. 10 illustrates an embodiment for maneuvering a robot across a floor incorporating the sensing elements and smart floor concepts described above.

### DETAILED DESCRIPTION

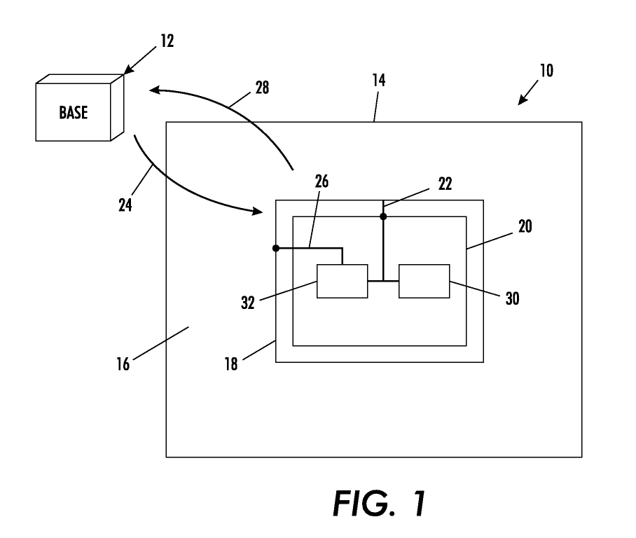

Turning to FIG. 1, set forth is a passive sensing element 10 and a base reader station 12. In this embodiment, sensing element 10 is designed on a back-side of tile 14 which may be used as flooring. It is to be understood, the tile may be made of ceramic, plastic, wood, carpet or any other appropriate material. It is also to be appreciated, while tile 14 is shown in a substantially square arrangement,.it may be formed in any number of other configurations.

Extending over a substantial portion of the back-side of tile 14 is a transducer 16, having properties which react to mechanical force such as pressure. A type of material appropriate for this use includes piezoelectric or piezo-polymers, one such piezo-polymer being polyvinylidene fluoride (PVDF), although other known materials which are capable of transforming mechanical pressure into an electrical based signal may be used. The transducer includes metal layers on the top and bottom surfaces of the piezo. The transducer may be laminated onto the back of tile 14, and will be flexible whereby it will come to an equilibrium with the stresses that result from the installation of the tile.

Transducer 16 is patterned to include a cutout portion 18, wherein transducer is not found. Located within cutout portion 18 is an RFID tag 20 with antenna 22. The RFID tag 20 and antenna 22 are connected to the back of tile 14 by appropriate conventional connection techniques. For example, the RFID tag 20 may be adhered to tile 14 by epoxy, and the antenna connected via conventional metallization techniques. The transducer may be laminated on the back of the floor tile or other flooring, using known lamination techniques.

In one embodiment, transducer 16 is 4 to 5 cm on a side, the RFID tag 1 mm or less on the sides, and the antenna a conductive strip 4 to 8 cm in diameter. It is to be appreciated, these sizes are presented only as examples, and the exemplary embodiment is applicable to other sized components.

Base station 12 may be any conventional computing device, which includes capabilities of communicating wirelessly with sensing element 10. More particularly, when tile 14 is installed (i.e., the tile is laid down on a floor in a store, home, warehouse or other location), base station 12 will emit a beacon signal 24 to power up (i.e., energize) RFID tag 20. When the RFID tag is energized, and a person or object applies pressure on tile 14, an incremental compression of the transducer (e.g., PVDF) occurs, resulting in a voltage pulse being generated by transducer 16, which is transmitted on trigger line 26 as a trigger signal for RFID tag 20. The powered-up RFID tag receives the trigger signal, and radiates its tag identification (ID) data via an identification ID signal 28, which is received by base station 12. When no trigger signal is present, the RFID tag will remain silent, thereby avoiding excess RF signaling. Depending on the design of RFID tag 20, information in addition to the tag ID may be sent to base station 12.

To ensure that an RFID tag is active when a person or object has come across the tile, the frequency of beacon signal 24 is selected to be at a rate higher than the time it takes for a single footstep or object to move across the tile. Thus, within one estimated footstep or object movement, the RFID tag will receive more than a single beacon signal 24, to ensure RFID tag 20 will be active upon the application of pressure.

When beacon signal 24 is received via antenna 22, it is provided to input power block 30, which operates to power up the RFID tag in a conventional manner. The electrical signal generated by transducer 16, is provided to computational block 32, which includes known circuitry necessary to generate and output the tag ID as well as other data.

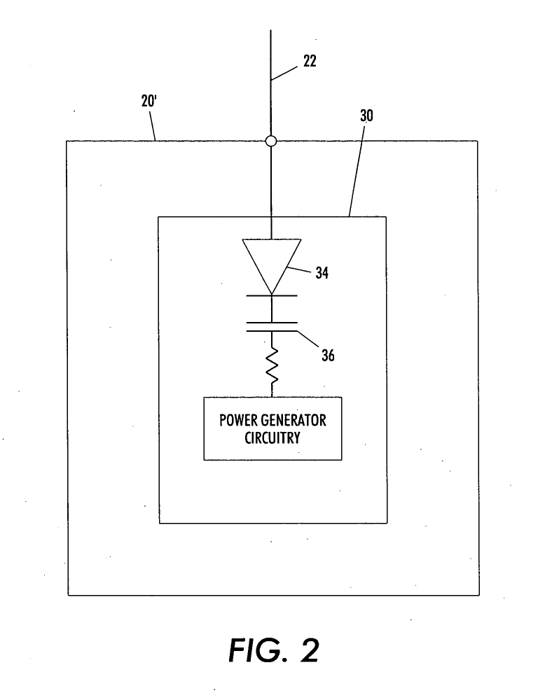

In an alternative embodiment illustrated in FIG. 2, input power block 30 of RFID tag-20′ may be designed whereby beacon signal (i.e., power-up signal) 24 is received at input power block 30 and is stored via a signal storage circuit including diode 34 and capacitor 36. This arrangement ensures there will be sufficient voltage at the RFID tag 20 when a trigger signal is generated on trigger line 26 (FIG. 1). Particularly, diode 34 permits voltage to charge up on capacitor 36, which in turn is selected with a decay rate to permit for the RFID tag to stay powered-up until a next beacon signal 24 is received. This embodiment permits for the possibility of lowering the beacon signal 24 frequency, while still maintaining sufficient voltage to keep the RFID powered-up until the next beacon signal. Of course, even with this design, the frequency of the beacon signal may be kept at its higher rate.

The concepts described in conjunction with FIGS. 1 and 2, as well as the following figures, find use in a setting where a large number of tiles and corresponding sensing elements are found. Thus, as may be understood and will be explained in greater detail below, the passive RFID tag on the back-side of each of a plurality of floor tiles are installed, and the switching on and off of specific tags (e.g., sending or not sending tag ID) is based on whether a person or object is applying pressure to a specific tile. By noting the time entry of such an action by base station 12, it is possible to track that person or object simply based on subsequent activations of adjacent tiles.

In order to have a system which is robust, it is desirable to have the majority of RFID tags inactive, so the responses of tags sending ID data can be received at close intervals in time.

It is to be appreciated that mechanical contact switches would be difficult to incorporate into floor tiles or other flooring due to excessive cost. Additionally, the reliability of such mechanical contact switches would be questionable. Thus, transducer 16 is used to trigger the RFID tag, since the transducer has high reliability as a switch, and it may be incorporated onto the back-side of the tile without negatively impacting the functionality of the tile as a floor covering.

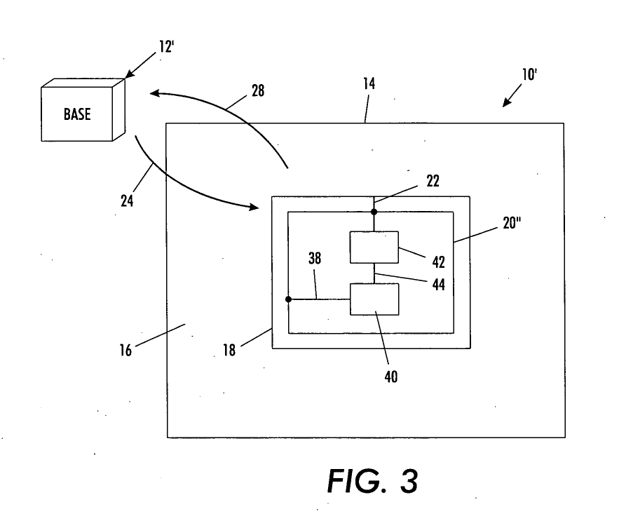

Turning to FIG. 3, set forth is an embodiment of an active sensing element 10′. In this design, similar to FIG. 1, the majority of the back surface of tile 14 is laminated with transducer 16, except for cutout portion 18. Located in cutout portion 18 is an RFID tag 20″ with antenna 22. In this embodiment, the output of the transducer (i.e., such as the PVDF) 16 is used not only to generate the trigger signal, but also to power up the RFID tag 20″, thus this design is configured in a self-powering arrangement. Connections of the transducer 16, RFID tag 20″ and antenna 22 are made to the back-side of the tile surface in a manner similar to that previously discussed in connection with FIG. 1.

As shown in FIG. 3, the scavenged power signal from transducer 16 is supplied, via power line 38 to input power block 40, which includes conventional circuitry to provide power for RFID tag 20″. Input power block 40 is further designed to supply a portion of the received signal to computational block 42 as a trigger signal, via trigger line 44. By this arrangement, the power-up operation takes place prior to providing the trigger signal to computational block 42 so that RFID tag 20″ is active. Once the trigger signal is received, computational block 42 generates a tag ID signal which is transmitted via antenna 22 and received by base station 12′. In this embodiment base station 12′ may be a passive base station which receives asynchronous RF pulses (i.e., the ID signals), but which does not need to emit power-up (i.e., beacon signals). The specific arrangement of circuitry will depend on the particular implementation, and numerous arrangements for the computational block would be known to one skilled in the art.

It is believed by applicants, the power output from a “heel strike generator” being developed by the Defense Department (DARA) is on the order of 1 to 2 watts. It is also believed by applicants the power available on the back-side of a floor tile may be reduced. If the power were to be reduced by 50 times, this could still be on the order of 20 to 40 milliwatts. It also noted that typical powering for the active RFID tag is 10 milliwatts, with a range of up to 350 feet. Thus, it is applicants' position that sufficient energy can be generated by transducer 16 for operation in this embodiment. The above values are provided only to illustrate that available power exists for this design, and are not intended to limit the concepts described herein.

In the above embodiments, the transducer (e.g., PVDF) 16 and the RFID antenna 22 may be laminated together onto the backside of the floor tile. The RFID tag (20, 20′, 20″), at least in part, may be in the form of a small silicon chip, which can be bonded with conductive epoxy to the tile and coated with an encapsulant.

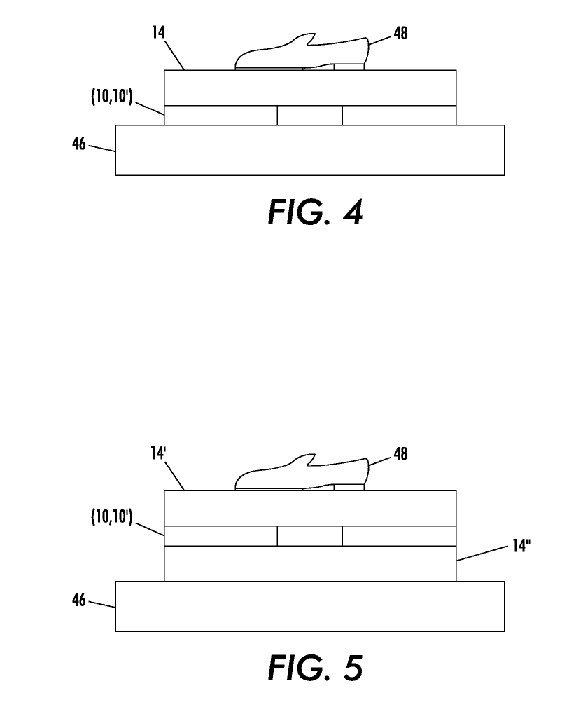

Turning to FIG. 4, depicted is a side view of an installed tile 14 having a sensing element (10, 10′) attached to its back surface. In this design the sensing element (10, 10′) comes into contact with sub-floor 46, and mechanical pressure is applied by foot 48. In an alternative embodiment, sensing element (10, 10′) is shown embedded between a first tile portion 14′ and a second tile portion 14″, the two portions, are laminated together thus incorporating sensing element (10, 10′) into the middle of the floor tile, separating the floor tile from subflooring 46.

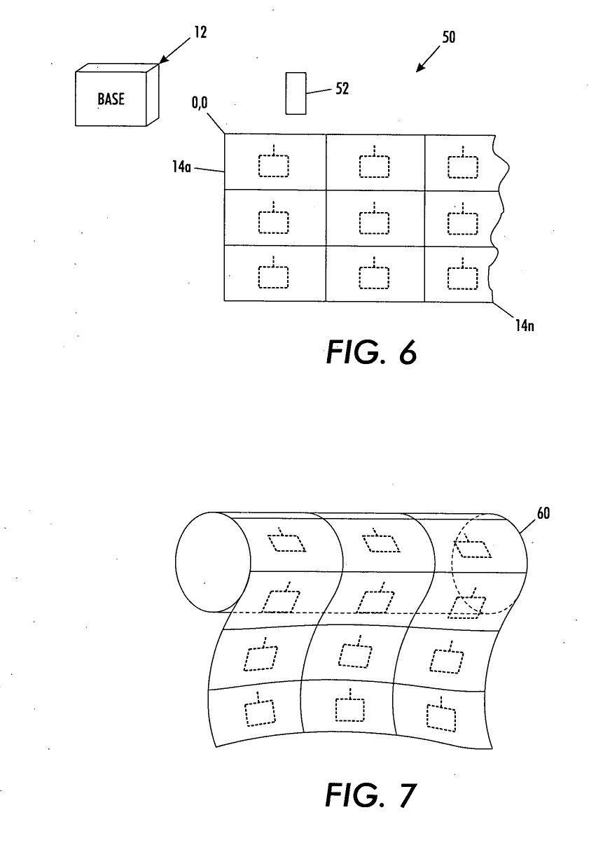

Turning to FIG. 6, depicted is a tracking system 50 incorporating the concepts described above. In this embodiment, a plurality of tiles 14a-14n have been installed. The dotted portions of the drawing indicate the RFID tags of either of the sensing elements 10, 10′. For convenience of description, the transducer is not shown. The following describes an initialization of the sensing element (10, 10′). Particularly, a handheld RFID reader-locator 52 would, in one embodiment, be moved across the tiles, such as across tile 14a. The RFID reader/locator 52 reads the RFID tag, identifying the tag, and stores the position of the tile based on an x,y co-ordinate system, or other appropriate position identification system. The user would then move to successive tiles and repeat the process, passing the RFID reader-locator over each of the tiles through 14n. In this way, each tile is associated with a position on the x,y coordinate system. Information obtained by the RFID reader-locator 52 is then provided to base station (12, 12′). By this initialization operation, the base station, can correlate the received tag ID to a particular position on the x,y coordinate. Alternatively, the position information may be maintained in the RFID tag, and passed to the base station, along with its ID signal.

With attention to FIG. 7, while the previous embodiments discuss the use of the sensing elements 10, 10′ located on tiles, these sensing elements may also be applied to roll stock flooring, such as linoleum, or carpet 60. In this embodiment, the transducer 16, such as the PVDF or other piezo material, along with the RFID antenna, are laminated in either a separate or combined lamination procedure in a roll-type process. The small silicon chip of the RFID tag could thereafter be bonded by the previously discussed processes. Such an embodiment could increase the productivity and throughput of the system. It is to be understood the initialization of FIG. 6, may also be implemented in a design such as in FIG. 7.

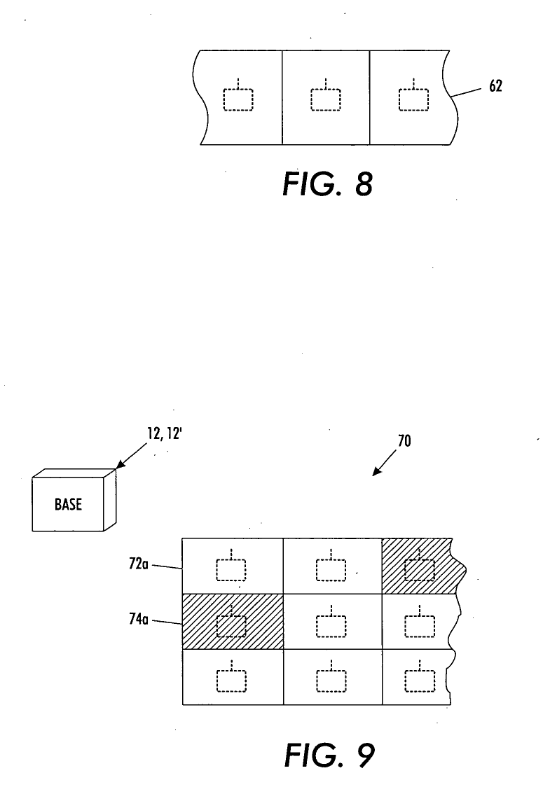

Similar to FIG. 7, a further embodiment, as shown in FIG. 8, would apply the sensing element (10, 10′) to another roll product, such as road-tape 62, which is used to form temporary road lines during road repair work, as well as use as crosswalk markings. The road-tape is highly durable. Similar to the embodiment in FIG. 7, the transducer material and RFID antennas may be laminated in a roll-type process, and the chip of the RFID tag attached later.

In alternative designs, other fabrication techniques for connecting the sensing elements may include having the transducer made of PZT, being screen-printed and laser transferred onto a flexible circuit that includes the RFID silicone chip and antenna. The entire structure may then be laminated to the floor tile. In another embodiment, circuits of the RFID tag may be formed on ceramic tiles in their green form, incorporating PZT and then have these co-fired to form a final product. In either of these embodiments, the resulting structures are represented by the previous figures. Also, aspects of the above fabrication techniques may be found in U.S. patent application Ser. No. 11/017,325 filed Oct. 20, 2004, entitled “A METHOD FOR FORMING CERAMIC THICK FILM ELEMENT ARRAYS,” by Buhler, et al.; application Ser. No. 10/376,544, filed Feb. 25, 2003, entitled “METHODS TO MAKE PIEZOELECTRIC CERAMIC THICK FILM ARRAY AND SINGLE ELEMENTS AND DEVICES,” by Baomin Xu; and application Ser. No. 10/376,527, filed Feb. 25, 2003, entitled “LARGE DIMENSION, FLEXIBLE PIEZOELECTRIC CERAMIC TAPES,” by Baomin Xu, et al., all of which are hereby fully incorporated by reference.

The above-described processes for generating smart flooring may be useful in a variety of applications. For example, the smart floor tiles and roll stock would be able to detect unsafe or adverse conditions, such as a wet floor or flooding.

The above-described components and systems may be also implemented in a multi-hop network such as shown, for example, in FIG. 9. In this embodiment, smart flooring 70 are tiles or roll stock. In addition to tiles or areas of the roll stock 72a, configured in accordance with the previous examples, there are a number of special tiles or areas 74a-74n, which are implemented as repeaters for multi-hop networks. These repeater tiles or areas 74a-74n may have internal batteries to permit a constant state of power. For replacement purposes, the tiles or areas are specially colored or otherwise identified to allow for easy maintenance, such as exchanging batteries after a certain time period. Thus, these tiles or flooring would be designed so as to be made accessible for exchanging batteries. For example, the tiles or areas could be installed in a non-permanent manner, such as with tape, Velcro®, etc.

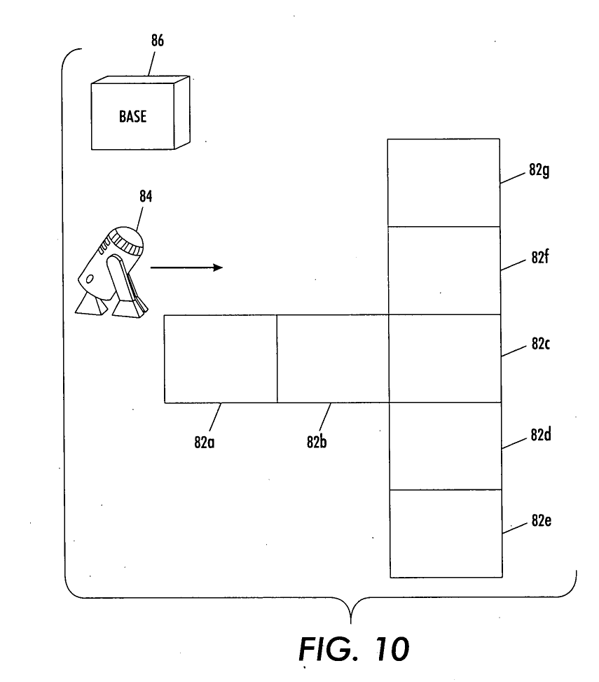

Turning to FIG. 10, depicted is another application in which the present concepts are implemented. More specifically shown is a portion of a smart floor 80 in the form of tiles or roll stock. For convenience, the tiles or areas of the roll stock are defined as 82a-82g. Energization of the smart tiles or areas may be accomplished by a separate base station 86, by signals from the robot itself, or by the self-powering configuration previously described. The concept is to provide for a robot 84 with a path to traverse across the smart floor 80 and reach a designated location. In one embodiment, the robot would have an RFID reader, which would communicate with the smart tiles or areas 82a-82g. Particularly, as the robot 84 crosses a tile (e.g. 82a), the pressure is sensed, and the tag is identified. The robot then communicates with the active tile or area, wherein not only is the tag ID provided to the robot, but additional information, such as an instruction to move in a particular direction. For example, when communicating with tile or area 82a, the RFID tag transmit an instruction for the robot to move forward. This would cause it to move across tile 82b, which may also emit an instruction to continue its forward path. Thereafter, when the robot communicates with tile or area 82c, an instruction is to turn to the right, thus moving the robot across tiles 82d and 82e. Again, by this design, robot 84 moves in a direction away from tiles 82f and 82g, due to the pre-stored and emitted instructions. In an alternative embodiment, the robot itself may have the instructions, and simply uses the identification of the tag to continue on its path. For example, robot 84 will have stored on-board instructions which command it to traverse tiles or areas 82a-82e. Thus, when it senses it is at tile or area 82a, its instructions would be to continue to move forward. Then when it reads that it is as tile 82c, it would have an instruction to turn right (i.e., across tiles 82d, 82e).

Further, the tiles (in addition to the road-tape) with sensor elements (10, 10′) could be used to emit signals from the roadbeds as cars pass over. This eliminates the need for extensive wiring to inductive pickup devices at intersections.

It will be appreciated that various of the above-disclosed and other features and functions, or alternatives thereof, may be desirably combined into other different systems or applications. Also that various presently unforeseen or unanticipated alternatives, modifications, variations or improvements therein may be subsequently made by those skilled in the art which are also intended to be encompassed by the following claims.

1. A sensing arrangement comprising:
a transducer configured to convert mechanical pressure into an electrical signal; and
an RFID tag operationally associated with the transducer, wherein the transducer is larger on a side than the RFID tag, the RFID tag having a computational block configured to employ at least a portion of the electrical signal as a trigger signal, wherein in response to the trigger signal the RFID tag generates and transmits an RFID identification signal.

2. The sensing arrangement according to claim 1, wherein the transducer includes at least one of a piezo-polymer or piezo-ceramic.

3. The sensing arrangement according to claim 1, wherein the transducer includes at least one of a PVDF or PZT.

4. The sensing arrangement according to claim 1, wherein the transducer and RFID tag are integrated on a back-side surface of a flooring material to form a sensing element.

5. The sensing arrangement according to claim 4, wherein the flooring material is at least one of tile or roll stock flooring.

6. The sensing arrangement according to claim 1, wherein the transducer and RFID tag are integrated on a back-side surface of road-tape to form a sensing element.

7. The sensing arrangement of claim 1, further including:
a base reader station configured to emit a beacon signal receivable by the RFID tag, the beacon signal designed to energize the RFID tag.

8. The sensing arrangement of claim 7, wherein an input power block includes a signal storage circuit which stores voltage generated from the beacon signal.

9. A sensing arrangement comprising:
a transducer configured to convert mechanical pressure into an electrical signal; and
an RFID tag having an input power block configured to receive at least a portion of the electrical signal as a power input for energization of the RFID tag, and a computational block configured to employ at least a portion of the electrical signal as a trigger signal, wherein in response to the trigger signal, the RFID tag generates and transmits an RFID identification signal.

10. The sensing arrangement according to claim 9, wherein the transducer and RFID tag are integrated on a back-side surface of a flooring material as a sensing element.

11. The sensing arrangement according to claim 10, wherein the flooring material is at least one of tile or roll stock flooring.

12. The sensing arrangement according to claim 9, wherein the transducer and RFID tag are integrated on a back-side surface of road-tape as a sensing element.

13. The sensing arrangement according to claim 9, further including a base station in operative communication with the RFID tag, the base station is a passive base station which only receives the RFID identification signal.

14. A sensing system comprising:
a plurality of sensing elements permanently associated with a back side surface of corresponding portions of a permanently installed flooring material, each of the sensing elements having a transducer configured to convert mechanical pressure into an electrical signal, and an RFID tag configuration designed to receive and employ at least a portion of the electrical signal as a trigger signal designed to cause the RFID tag to emit an identification signal; and
a base station configured to receive the RFID identification signal.

15. The sensing system according to claim 14, further including an input power block configured to receive at least a portion of the electrical signal to energize the RFID tag.

16. The sensing system according to claim 14, further including a robot configured to read the sensing elements to determine a travel path.

17. The sensing system according to claim 14, wherein the sensing elements include instructions for controlling movement of a robot.

18. The sensing system according to claim 14, further including a repeater, wherein the system is used as a multi-hop communication network.

19. A sensing method comprising:
associating a sensing element including an RFID tag and transducer on a back side surface of at least one of flooring material or road tape;
sensing mechanical pressure on the transducer of the sensing element;
converting the mechanical pressure into an electrical signal, at least a portion of the electrical signal being used as a trigger signal;
transmitting the electrical trigger signal to the RFID tag of the sensing element;
generating, by the RFID tag, an RFID tag identification signal, following receipt of the trigger signal; and
receiving by the base station the RFID tag identification signal.

20. The sensing method according to claim 19, further including an energizing step which uses at least a portion of the electrical signal as the energization signal, to power-up the RFID tag, the power-up of the RFID tag occurring prior to generation of the RFID tag identification signal.

21. The sensing method according to claim 19, wherein the transducer includes use of a piezo material.

22. (canceled)

23. (canceled)

24. The sensing arrangement of claim 1, further including a plurality of pairs of the operationally associated transducer and RFID tag, each of the pairs associated with a back side surface of a flooring material to form a smart floor configured to track movement across the smart floor over at least a sub-group of the plurality of pairs, wherein the transducer of the pairs covers a majority of the back side surface.

25. The sensing arrangement according to claim 1, wherein the transducer is at least ten times larger on a side than the RFID tag.

26. The sensing arrangement of claim 9, wherein the transducer is configured to generate wattage in a range of between more than 10 milliwatts and up to 2 watts.

27. The sensing arrangement of claim 9, wherein the transducer is configured to generate between 20 milliwatts to 40 milliwatts.
